(19) United States
(12) Patent Application Publication
(10) Pub. No.: US 2017/0278117 A1
(43) Pub. Date: Sep. 28, 2017

(54) CUSTOMER EXPERIENCE PERSONALISATION MANAGEMENT PLATFORM

(71) Applicant: FLAMINGO VENTURES PTY LTD

(72) Inventors: Catriona WALLACE, Sydney NSW (AU); Julie TRAJKOVSKI, Sydney NSW (AU); Angela GAMMO, Sydney NSW (AU)

(21) Appl. No.: 15/521,890

(22) PCT Filed: Oct. 27, 2015
(86) PCT No.: PCT/AU2015/050671

§ 371 Date: Apr. 25, 2017

Related U.S. Application Data
(60) Provisional application No. 62/069,224, filed on Oct. 27, 2014.

(51) Int. Cl. G06Q 30/02

(52) U.S. Cl. CPC G06Q 30/0203; G06Q 30/0271; G06Q 30/0206

(57) ABSTRACT

Methods and systems for allowing multiple parties to coordinate, including a computer server in communication with a network and a database, the computer server configured to run the platform and allow a vendor user to, and invite a customer user to use the platform via the network. Also, research the customer user by sending questions to the customer user and receive responses to the questions from the customer user, wherein the questions include stored platform questions, and prompt the customer user to upload personal information from a personal networked storage. In addition, send the customer user a product preferences template, receive answers to the product preferences template from the customer user via the network, and offer products to the customer user based on the received responses.

### CROSS REFERENCE TO RELATED CASES

This application claims priority from U.S. provisional application 62/069,224 which was filed on 27 Oct. 2014 the entirety of which is hereby incorporated by reference.

### FIELD OF THE INVENTION

This application relates to the field of data processing and user interaction via networked computer systems.

### BACKGROUND OF THE INVENTION

Traditional models of business are based on industrial design and treatment of individuals en-mass. Previously this was an efficient model for business however now with increased sophistication of customers and empowerment through networked digital methods and systems, customers are demanding to have their products, services and experiences personalised to their individual needs. Current systems of Customer Relationship Management (CRM) and data analytics provide some insight into customer behavior however typically not at an individual level that is an accurate reflection of what the individual customer wants.

Customizing offers for products and services was not easily done without proper management of data and questions to customers. This problem may be addressed using networked data storage and customer interaction.

### SUMMARY

Systems and methods here include a platform for allowing multiple parties to coordinate, including one or multiple computer servers and databases with the computer servers and databases configured to run the platform and allow a vendor user to, invite a customer user to use the platform, research the customer user by sending questions to the customer user and receive responses to the questions from the customer user, wherein the questions include stored platform questions, prompt the customer user to upload information manually or from their personal networked storage, send the customer user a product preferences template, receive answers to the product preferences template from the customer user, offer products to the customer user based on the received responses, the computer server further configured to, store details in the database, wherein details include, the responses to the questions and answers to the product preferences template, and send the stored details to a third party application server via the network.

Certain embodiments may include the ability for a customer to enter their payment or invoicing information as a response to vendor questions if the customer wishes to purchase a product or a service.

Certain embodiments may include a platform to allow networked coordination of medical services vendors and customers, a server in communication with a data storage and a network, the server configured to run the platform to, allow customer users to log into the platform via the network, prompt the customer users to upload their medical/personal data to the data storage, cause storage in the data storage of uploaded customer user data, prompt the customer user to identify personal preferences, receive identified customer user personal preferences, based on the identified customer user personal preferences, prompt the customer user to choose a product/service, select a template based on the chosen product/service, load the stored data into the selected template, prompt the customer user to answer questions based on the chosen product/template, receive answers to the questions and load the answers into the selected template, and send the template to a third party application server.

Certain embodiments may include the ability for a customer to synchronise information from other devices (including wearable devices) so that if they choose, they can have this data also uploaded to the platform via the network. This data can be used to better understand the customer and their preferences so that vendors can better serve them.

Certain embodiments may include a platform to allow networked coordination of medical services vendors and customers, including a processor in communication with a memory, data storage and a network, the processor configured to execute instructions for, communicating with a customer via the network using instant messages, recalling a template for research questions, based on a type of product, sending questions to the customer from the template, receiving answers to the questions from the customer, correlating the answers to the questions with product offerings, sending product or service offerings to the customer based on correlated answers, receiving a product selection of the product offerings from the customer, causing storage in the data storage of the answers to questions, experience variable responses and product selection, and sending the product selection to a third party application via the network.

Certain embodiments may include the tools for verifying a customer's identity.

### BRIEF DESCRIPTION OF THE DRAWINGS

FIG. 1 shows an example network diagram to utilize the platform consistent with certain embodiments herein.

FIG. 2 shows example the high-level elements of the invention consistent with certain embodiments herein.

FIG. 3 shows more example high-level elements of the platform consistent with certain embodiments herein.

FIG. 4 shows example flow charts depicting example flow processes consistent with certain embodiments herein.

FIG. 5 shows example flow charts consistent with certain embodiments herein.

FIG. 6 shows a continuation of the example flow chart of FIG. 5 consistent with certain embodiments herein.

FIG. 7 shows another example flow chart consistent with certain embodiments herein.

FIG. 8 shows an example computing device which may be used to practice certain embodiments herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

With networked computer systems, utilizing various programs for business, Customers and Vendors interact and engage with each other using various methods and systems. Certain embodiments here concentrate on customer and vendor interaction at an individual level, more specifically, using a platform supporting processes surrounding the interaction between vendors and their customers over a network employing remote data storage and retrieval and any of various communication methods.

Embodiments here include working with businesses who may not know their own customers or are unable to deliver experiences to customers as individuals. This may fall into the field of Vendor Relationship Management (VRM) or be regarded as the next generation of customer resource management CRM where customers are able to directly cast their intentions to business.

For example, vendors may not know their customers to the level required to meet their real needs. Further, customers may not be engaged with the vendor to the degree desired by the vendor or the customer. The field of customer and vendor relationships has historically been dominated by CRM systems. VRM systems have more recently emerged and address the same space as CRM system, but from the customer's perspective. Certain embodiments here deal with the fields of CRM and VRM, and the interaction between these fields.

In certain embodiments, the platform here may be configured to support the interaction between the vendor and the customer by a process of co-creation whereby the vendor and the customer share information using the platform. Each action or step in the process could be viewed by the customer and at the same time by the vendor, each having a different view so as to assist each in their understanding of the process and the options therein.

In certain example embodiments, the business may use the system to interact with customers, and in some embodiments, a business may use the system to interact with employees. Customers may be clients of the business users. In some embodiments, a vendor could be the role that the business plays when it sells products or services. In certain embodiments, a buyer could be the role that customers play when they buy products and services from the business. In certain embodiments, a co-creator could be a role that an employee of the business and the customer (or employee of the customers) collectively play when they co-create.

### Networked Examples

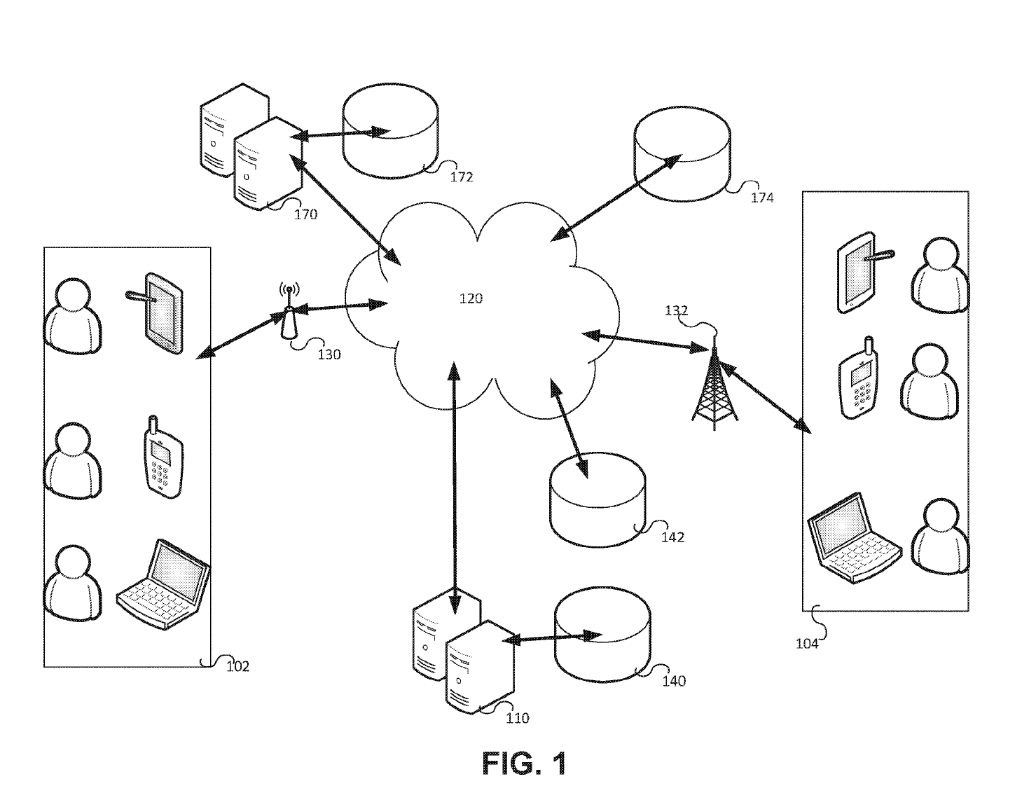

FIG. 1 shows an example network diagram utilizing various platforms to interact with the customers and vendors described herein. In the example, customer users 102 and vendor users 104 each have any of various devices and consoles (examples include but are not limited to, computer console, smartphone, tablet, laptop, wearable computer such as a watch or glasses) to connect to the system 110 via a network including via the internet 120. In such a way, the customer devices 102 and vendor devices 104 need not be in the same location, and can actually interact anywhere the devices are able to connect to the internet 120. In certain circumstances the customer and the vendor may be in the same location whereby they could be shoulder-to-shoulder sharing a local visualization of the invention.

Such connection and communication could be through any of various wired or wireless computer interactions through such systems as, but not limited to, cellular, Wi-Fi, picocell, femtocell, Bluetooth Low Energy, near field communications, or other wireless communication methods and systems. The example in FIG. 1 shows the customer devices 102 connecting via a WiFi connection 130 and the vendor devices 104 connecting via a cellular tower connection 132, but these examples are merely illustrative, and any form of wired or wireless connection may be used to communicate.

Further, such networked systems may allow for the back end platform systems 110 to likewise interact with both the customers 102 and vendors 104 and also utilize any number of networked data storage including local storage 140, cloud storage 142, as well as utilize virtual machines for data processing.

Further, such networked systems may allow for vendor's platform systems 170 to interact with the back end platform systems 110. Within the bounds of configured security settings, data may be shared and updated (read and write) between the back end platform systems 110 and the vendor's platform systems 170 and also utilize any number of networked data storage including local storage 172, cloud storage 174, as well as utilize virtual machines for data processing. An example of a vendor's platform systems 170 could be their existing CRM back end system. In any particular case data may be shared and updated (read and write) between the back end platform systems 110 and multiple vendor platform systems, examples of these could be the vendor's billing system, the vendor's financial system and the vendor's logistics system.

### Example Features

Certain example features may be used by the platform in the network described above. Such example platforms could be used to allow customers and vendors to co-create customer experiences either remotely or face-to-face. Various example platforms can be configured to interact with two entities such as both customers and vendors to support a range of functions, such as empowering the customer to manage their experience with the vendor and enabling the vendor to interact with the customer as an individual.

The customer's experience historically would be limited to their selection of product options, or configurations, offered by the vendor, or price negotiation. Certain embodiments here may extend this experience to experience elements beyond product options and price, these new experience elements (are described in detail below) could include but not be limited to the customer's communication experience, the customer's channel experience, the customer's process experience and the customer's people experience. Below are examples of certain example features:

The Journey Assist feature which may be based on the Customer Experience model and Human-Centred Design components.

The Journey Avatar feature that automates communications from a creator (employee from an organization) to a customer including Cruise Control where questions are asked with the creator logged in and watching, Journey Automation, where questions are asked with or without creators logged in, and the full Journey Avatar machine learning AI that can also interact with customers and escalate if a response can not be found that is suitable for the customer.

The Personaliser feature may provide the ability to automatically configure and individualize a customer's experiences.

The Analyzer features analysis of data within the platform to compare the outcomes from various customer journeys enabling the vendor to promote journeys that provide outcomes that the business targets, and demote journeys that do not. This process could be automated such that journeys may be promoted or demoted automatically. Analyzer information and features may be used in conjunction with Journey Avatar to better automate the feature.

The Personal Cloud capability for remote, secure storage and sharing of personal data under the control and authorization of the customer.

The Co-Creation Model enabling customers and employees to design and implement experiences customers want and that the business can deliver.

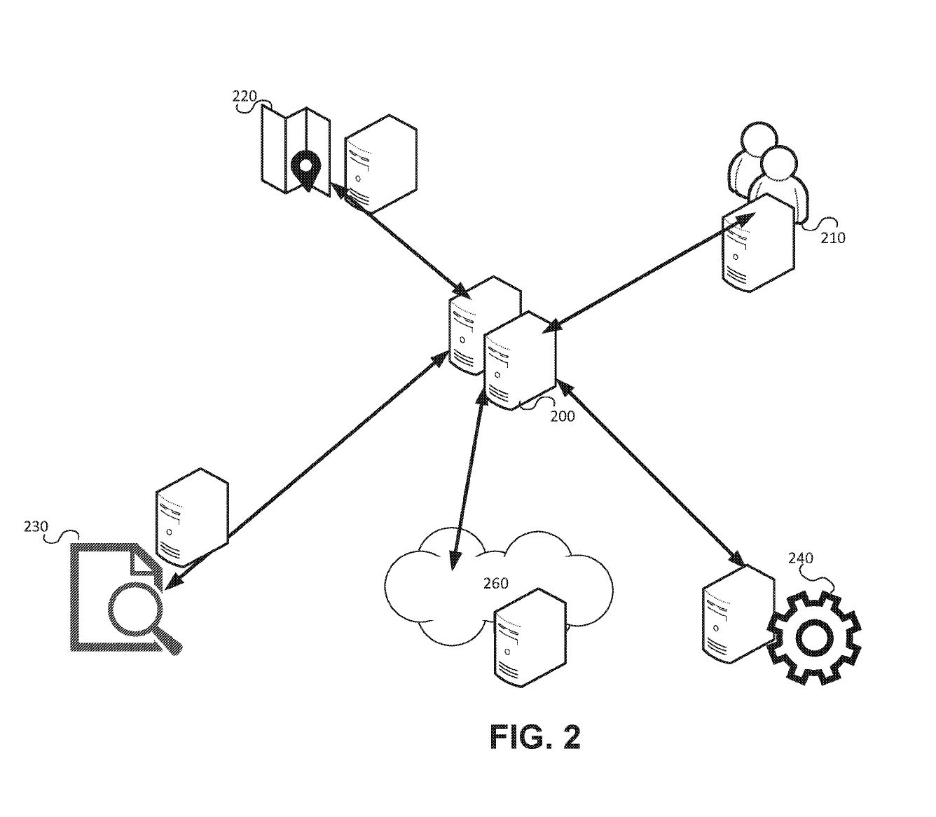

FIG. 2 shows a high level example of the platform 200 being used for a vendor to interact with a customer. Shown in the example of FIG. 2 are various features that may be used in such a way, including: Journey Assist 220; Integration platform 240; Personaliser 210; Analyzer 230; and Personal Cloud 260.

Thus, the platform 200 can manage and draw upon the various featured embodiments that the overall platform system can offer. Although the individual features are depicted as separate servers or systems, they could be integrated together, blended in any way and do not necessarily exist as separate entities or embodiments.

Invitation to a Customer

In certain examples, the platform may be configured by the vendor to issue an invitation to a customer. This example invitation could be via the internet, using a mobile application on a smartphone or other such wireless device. Such an example invitation could allow the customer to enter the networked platform online in order to interact with an employee from the vendor.

The interaction could be for any of various things including but not limited to buying a product, service or experience; renewing a product, service or experience; solving a problem; seeking, communicating or updating information or any of other various examples. A product could be any number of things including but not limited to a banking product or service (examples may include but are not limited to: mortgage, personal loan, credit card, debit card, business loan, overdraft, short-term deposit, long-term deposit, foreign exchange transaction), an insurance product or service (examples may include but are not limited to: health insurance, life insurance, car insurance, house insurance, workers compensation insurance, business insurance), a utility product or service (examples may include but are not limited to: electricity, gas, water, home phone, mobile (cellular) phone, internet, cable television), an internet product or service (examples may include but are not limited to: real estate sales, consumer product sales, employment services), health services (may include but are not limited to: medical practice, hospital, health clinic, physiotherapy clinic) or government services.

Co-Creation Lab

In the example, the employee may virtually meet the customer via a graphical user interface (GUI) to a platform, which may be referred to as a Co-creation Lab, and utilize Human-Centered Designed journey templates to guide the customer through a Customer Journey.

Human-Centered Designed Journey Templates

Journey templates may be designed using Human-Centered Design (HCD) techniques. An example of a Human-Centered Design may be one where the steps for interaction are driven by the customer, as opposed to being designed from the businesses point of view. This allows for maximum customization, delivering what the customer wants instead of forcing the customer to navigate a set path.

Customer Journey

A Customer Journey may refer to the path, or process, that the customer and the vendor co-creators follow through the co-creation lab. This path could include any number of questions and answers which in turn lead to different questions and answers. The previous answers informing the later questions. In a choose-you-own adventure model, the customer could then benefit from receiving customized and tailored information without having to navigate through superfluous material.

Journey Template

A Journey Template may refer to a templated customer journey. The customer journey may be templated, that is, presented to the co-creators as a pre-configured journey that the co-creators may choose to follow. The co-creators may follow the templated journey exactly, or vary the journey for various reasons, for example based on responses by the customer co-creator, or suggestions by the vendor co-creator. In this way, the template may allow for flexibility of later questions and answers, based on previous answers. But instead of starting from scratch, a Journey Template can help a vendor start on a topic and begin guiding a customer through an interaction that will provide the best service possible.

The journey templates may be designed using HCD techniques and will be informed by the inventor's experience in the field of Customer Experience.

Research Validated Model

A Research Validated Model may be a model or construct that has been designed or built based on analytical research. In certain example embodiments, a co-creation lab could utilize online instant message or chat functionality for the two parties, such as a vendor employee and customer to interact over the network. Such examples could include GUI renderings of speech bubbles with icons or pictures, color coded speech bubbles, or other instant messaging or text messaging GUI profiles. Additionally if the customer prefers the conversation exchange can be done using a voice over internet protocol (VoIP) audio connection, or video such as Skype, or Facetime or other video chat system.

An example Customer Journey system could incorporate both Human-Centered Design principles and a research validated model of Customer Experiences.

Customer Experience Categories may be categories, or types of customer experiences that a particular customer may choose from. A menu of available customizable options may then be selected from among in order for a customer to keep the information topical and relevant to them, and deliver that material in the preferred manner. Examples include, but would not be limited to:
1. Communication—how the customer wants the business to communicate with them, for example, do they want to be communicated with formally, efficiently and/or casually): what information is the customer willing to share with the vendor (for example but not limited to: personal details, driver's license details, passport details, employment details, income details, health details house value, spouse details), through which communication channels, at which frequency;
2. Channel—how suitable the interaction channels to the customer's requirements and preferences e.g. website, mobile site or app, via 3rd party APIs, call center, face-to-face, social media, voice, text, email, instant message;
3. Process—how easy is the process for the customer to undertake in a manner that suits the customer e.g. self-service versus assisted by a live attendant;
4. People—how the customer is treated by the people of the business in a way that is suitable to them e.g. titles to use for particular people, cultural idiosyncrasies, how to treat people with various levels of formal respect, staff member is knowledgeable about the customer;
5. Product—how customized the product or service is to suit the needs of the individual customer; and
6. Price—the price the customer is willing to pay, and the value they perceive, for the whole of their experience across the total customer experience across the categories described above. The price could be suggested by the customer which the vendor may accept, or negotiate a different price. A possible alternative would be the vendor suggests a price which the customer may accept or negotiate a different price.

Other journey templates may be available to a vendor, in order to help tailor an experience for a particular customer. Below are some non-limiting examples:

Key Template—A Key Template may refer to a journey assist template designed to achieve a particular business outcome. Examples of such Key Templates may include: acquisition, retention, win-back, innovation, concierge, research, form-assist and supporter.

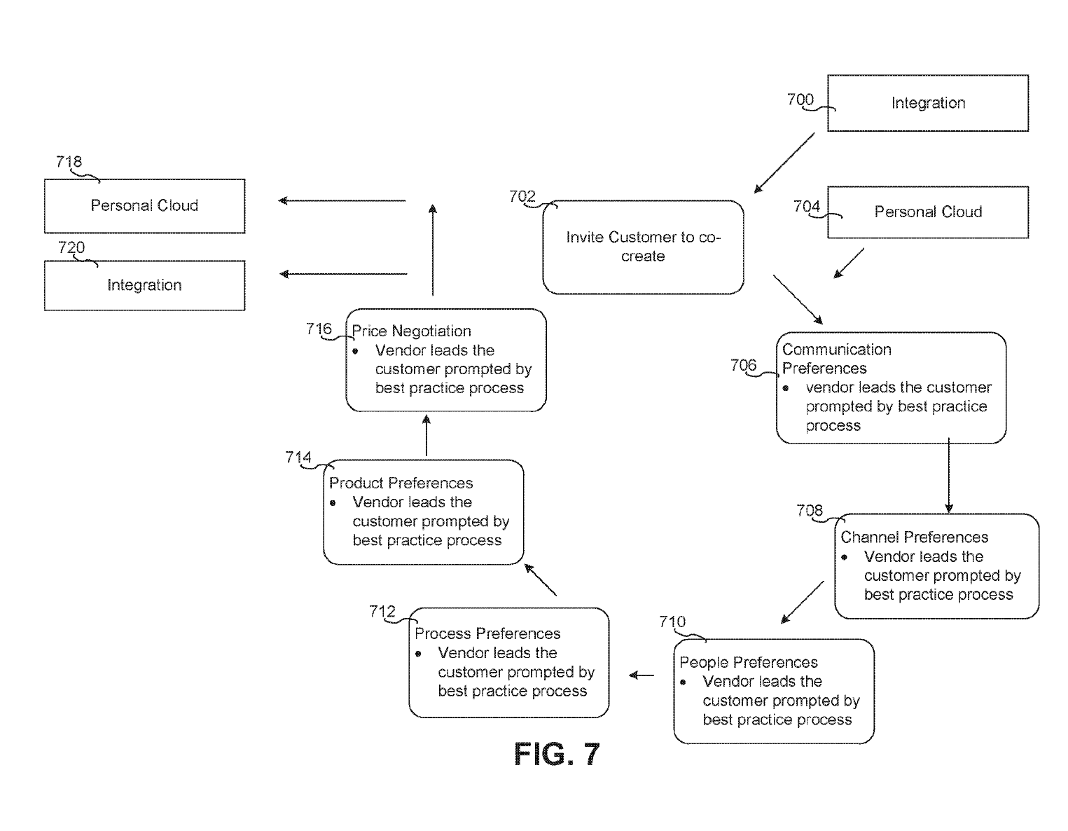

Acquisition Template may refer to templated steps that allow the vendor employee to guide a customer through a journey or online process based on Human-Centered Design principles in order to purchase a product, service or experience. See FIG. 7 The process could start with the vendor identifying the customer/prospect as a candidate for Acquisition, as an example this identification may have been done by the vendor's CRM system. The vendor could then invite the customer to co-create, in such a case, the integration between the system and the vendor's CRM system provides this capability. There could be a range of functions associated with this invitation, including but not limited to: calendar functions to book the co-creation event.

Quotation Template may refer to steps that allow the vendor to collect enough information to provide a quote for a product or service to a customer. This may form a part of an acquisition template, lead into an acquisition template, or be separate.

As the co-creation begins, the vendor may invite the customer to push data from their personal cloud, if the customer has one. Depending on the content of the Personal Cloud, and the authority given by the customer, the personal cloud would inform the system of some, many, most, or all of the customer's experience preferences and personal data. The process of co-creation would then proceed with the vendor leading the customer through each customer experience category (including but not limited to Communication, Channel, People, Process Product and Price) while being prompted by templated best practice for each customer experience for a customer Acquisition journey. As this process progresses all of the customer experience preferences may be captured. At the end of the process the customer may save whichever of their experience preferences or data they choose, into their personal cloud. Also at the end of the process the system can push data via integration to third-party applications to automate the fulfillment of the co-creation.

Retention Template may refer to templated steps that allow the vendor employee to guide a customer through a journey or online process based on Human-Centered Design principles in order for the business to interact with the customer to review the customer's relationship with the business. The process enables the employee to understand and address the individual customer's needs and thereby retain their business. See FIG. 7 The process could be the same as the Acquisition example in the paragraph above except in this case the vendor's CRM system would have identified the customer as a candidate for Retention. In this example the vendor would be prompted by templated best practice for each customer experience for a customer Retention journey.

Win-back Template may refer to templated steps that allow the vendor employee to guide a customer through a journey or online process based on Human-Centered Design principles in order for the business to interact with an individual who is no longer a customer of a business. The process enables the employee to reviews the customer's relationship and issues related to why they left the business thereby enabling the employee to understand and address the individual customer's needs, make certain offers and thereby win-back their business. Again the process could be the same as the Acquisition example in FIG. 7 except in this case the vendor's CRM system would have identified the customer as a candidate for Win-back and the vendor would be prompted by templated best practice for each customer experience for a customer Win-back journey.

Innovation Template may refer to templated steps that allow the vendor employee to guide a customer through a journey or online process based on Human-Centered Design principles in order for the business to test or generate ideas for innovations related to products, services or experiences with individual customers. As in the examples above for Acquisition, Retention and Win-back in FIG. 7 the process would be similar except that the vendor would be prompted by templated best practice for each customer experience for a customer Innovation journey.

Concierge Template may refer to templated steps that allow the vendor employee to guide a customer through a journey or online process based on Human-Centered Design principles where the vendor could use the platform to assist the customer to on-board for upcoming events or using new products or services. As in the examples above for Acquisition, Retention and Win-back in FIG. 7 the process would be similar except that the vendor would be prompted by templated best practice for each customer experience for a customer Concierge journey. Concierge examples could include, but would not be limited to, the vendor helping the customer to check in to a hotel or hospital, or the vendor helping the customer to review and select which sessions and events they wish to attend at a conference.

Research Template may refer to templated steps that allow the vendor employee to guide a customer through a journey or online process based on Human-Centered Design principles where the vendor could use the platform to gather information about the customer. As in the examples above for Acquisition, Retention and Win-back in FIG. 7, the process would be similar except that the vendor would be prompted by templated best practice for each customer experience for a customer Research journey. Research examples could include, but would not be limited to, the vendor recording the customer's name, address, phone numbers, email. Another Research example may be the vendor asking and storing the customer's banking details, identification details, credit details, income details, or health details.

Form-Assist Template may refer to templated steps that allow the vendor employee to guide a customer through a journey or online process based on Human-Centered Design principles where the vendor could use the platform to assist the customer to fill in forms. As in the examples above for Acquisition, Retention and Win-back in FIG. 7 the process would be similar except that the vendor would be prompted by templated best practice for each customer experience for a customer Form-Assist journey. Form-Assist examples could include, but would not be limited to, the vendor sharing an electronic credit application form on the customer's device and assisting the customer to complete it. Another example may be the vendor sharing an electronic registration form on the customer's device and assisting the customer to complete it.

Supporter Template may refer to templated steps that allow the employee to guide a customer through a journey or online process based on Human-Centered Design principles where the vendor could use the platform to provide support. As in the examples above for Acquisition, Retention and Win-back in FIG. 7 the process would be similar except that the vendor would be prompted by templated best practice for each customer experience for a customer Supporter journey. Supporter examples could include, but would not be limited to the vendor providing a personalised support function to the customer in health services, delivery, information technology support, general customer support, technical support, training support, and/or business support, for example.

Claims Template may refer to templated steps that allow the employee to guide a customer through a journey or online process based on Human-Centered Design principals where the vendor could use the platform to manage a claim for a customer.

Still referring to Journey Assist 220, in certain embodiments, the platform can take requirements communicated by the customer that cannot be currently met by the vendor, and record them against the customer record. Such requirements can be used as input for future offerings. Examples of requirements that the vendor cannot currently meet may be, for example, the product or service variant does not exist, or the vendor has not configured the platform to offer the variant.

The platform may capture the preferences the customer requests in the interaction and records for use in future interactions. Such example storage could be in FIG. 1 via the cloud storage 142 or local database storage 140.

### Personaliser Product Examples

Another example feature shown in FIG. 2 for use with this platform is experience Personaliser/Product Matcher 210. By using such features, the platform 200 may capture information shared by any number of the vendor platform systems 210.

In order to co-create the specifics of the experience required by the customer, the platform may use a Personaliser/Product Matcher 210 which may be a system that captures any or all of the various customer requirements across the whole of their Customer Experience Categories noted above, and best match them with what the organization is able to deliver. Hence the platform incorporates a Customer Experience Configurator which uniquely innovates existing customer experience configurations and manipulates them. This manipulation may be used to turn the focus of the customer's engagement from product, to a focus that includes all or some of the other Customer Experience Categories.

An example of what the Personaliser/Product Matcher 210 can be used for could be, the invention has gathered information about the customer's product preferences and uses this information to automatically configure product options that match the customer's preferences, within the bound of what the business can provide and wants to provide.

Another example of what the Personaliser/Product Matcher 210 can be used for could be, the invention has gathered information about the customer's product and price preferences and uses this information to automatically configure product options that match the customer's preferences, within the bound of what the business can provide and wants to provide, and that also meets the customer's price preference.

Another further example of what the Personaliser/Product Matcher 210 can be used for could be, the invention has gathered information about the customer's product, price and one, many or all of the Customer Experience Categories referred to above, preferences and uses this information to automatically configure a total customer experience that matched the customer's preferences, within the bound of what the business can provide and wants to provide.

### Analytics Examples

Another example feature shown in FIG. 2 of this platform is an Analyzer 230. This example feature may include allowing the platform to analyze data collected and generated elsewhere in the platform. By so collecting data from other examples, the platform may measure and compare the yield of various customer journeys, whether they be programmed or co-created. In this way, successful journeys may be repeated, studied more in depth, or emulated in order to maximize effectiveness. A rating system or scoring system may be applied to successful journeys. A database of popular or highly scoring journeys may be accessed by vendor employees for training or for use in later customer interactions. Favorites may be tagged with metadata to indicate which vendor employees prefer which templates. These may be shared among vendor employees to allow for customization of templates and discussion of the details of successful and unsuccessful journeys.

A system administrator may also wish to promote journey templates for various reasons. Promoted journey templates may be made available to vendor employees in order to expose them to templates that management feels are important or with trying. Additionally, there may be visibility by management of which templates are used by which vendor employees. In such a way, suggestions may be made to particular employees who are struggling, to use more successful templates. Control of templates could then be managed centrally and allow for analysis of not only template success but also employee success in conjunction with template selection.

In certain example embodiments, the platform may be configured to have the following analytical capabilities:

Real-time dashboarding and reporting of customer data that the business can access and review.

Real-time dashboarding and reporting of all data in the invention that the business can access and review.

Real-time dashboarding and reporting of all data in the invention across campaigns that the business can access and review.

Real-time dashboarding and reporting of all data in the invention, across all businesses that use the invention, that the inventor can access and review.

Analysis of the Customer Journeys completed and models of best-result Journeys determined. The system may assess which Customer Journeys and Journey steps are most likely to result in a successful outcome for the customer and the business and it may then reconfigure the templated customer journeys in order to have the Journey presented that is the most likely to result in a successful outcome.

### Personal Cloud Capability Examples

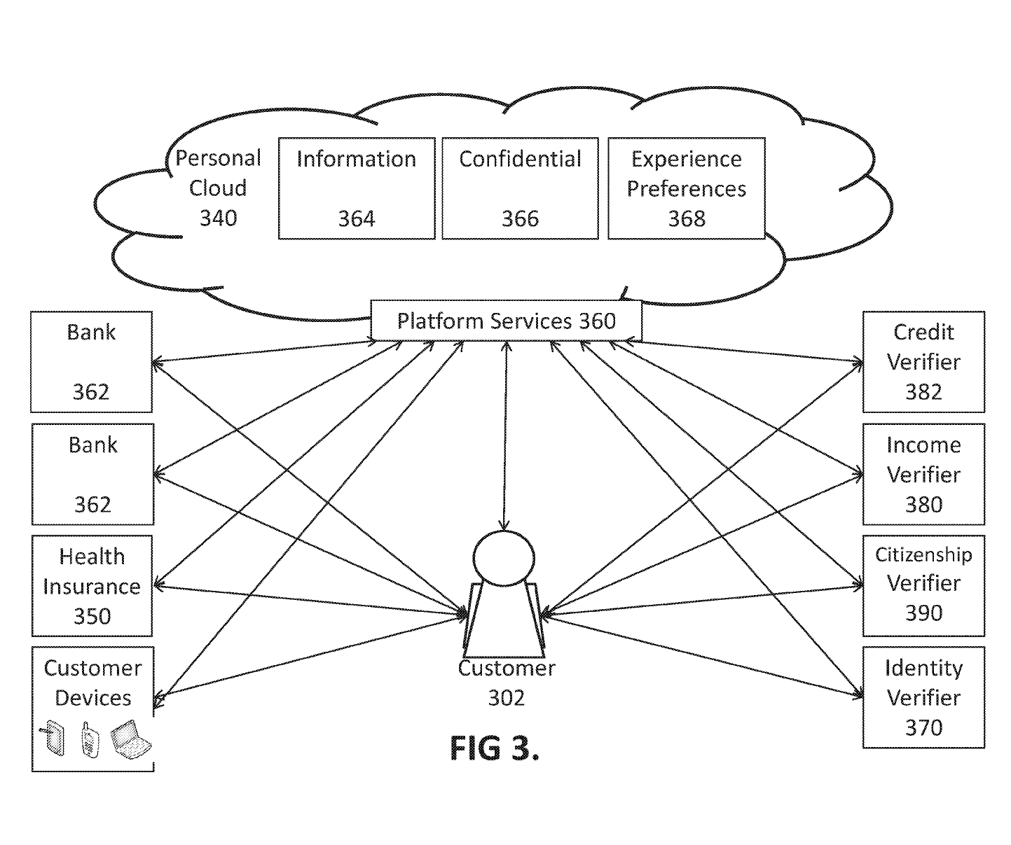

Another example feature from FIG. 2 which can be used by this platform is a Personal Cloud 260 feature. This personal cloud embodiment example is expanded upon in more detail in FIG. 3. In FIG. 3, the Personal Cloud 340 allows the platform 360 to store and make accessible any information, data, and/or experience that the customer has co-created with an employee.

In traditional business models the information created by the customer and vendor employee is only stored and controlled by the business. But in certain example embodiments here, the platform 360 may innovate this traditional model to allow the customer to store, access, manage and control their own data. Such features may allow the customer 302, next time they interact with the business, to not repeat information they have already provided. Instead, a personal cloud storage 340 feature could allow them to download their experience preferences 368 saved previously. Such example preferences could be any number of things such as communications, product, channel, process, people or price. Any kind of metrics, preferences from previous co-created templates, etc. could be used.

Certain example permissions could be used to meter such access. Additionally, templates or other examples could be used from other customers, the service provider, or other third party, for the customer to access, analyze and customize.

Thus, certain example embodiments may use a Personal Cloud platform 360 to provide the capability to store and manage data. In some embodiments, a customer 302 can choose to share their data on their Personal Cloud 340 with a vendor, or vendors, and other agencies. Further, a customer 302 could configure their Personal Cloud 340 to share specific types of data with specific vendors or other third parties. For example, a customer 302 could store any amount of personal information 364 such as next of kin, address, phone number, email address, etc. A customer could label certain of those information as confidential 366 such as income information, home loan information, medical, etc. Such a subset could be labeled as confidential health data and be shared only with their health insurer 350 for health insurance applications. A customer could label certain subset of information as confidential financial records 366 to share only with a bank 362 or other financial institution. Such information could be used for a loan application, for example. Another subset of data could be used as personal verification details 366 to be used with any number of institutions looking to verify identities of individuals, such as a bank or government department. Thus, certain Business Cloud capabilities could allow businesses to read the customer's Personal Cloud 340 but only those aspects of data that they need for their business, without exposing all of the personal data to all businesses. This compartmentalization may be tailored depending on the customers' preferences.

Personal Cloud platform 360 embodiments may store and source secure, validated data from networked third parties that a customer has a relationship with. For example, the customer may allow her bank 362 with which she has a previous relationship with, to upload financial information to the cloud 340, instead of the customer 302 supplying all of the data.

Such sources may include, but would not be limited to, an Identity Verifier 370 who holds and shares data that validates the customer's identity, an Income Verifier 380 who holds and shares data that validates the customer's income, an Citizenship Verifier 390 who holds and shares data that validates the customer's Citizenship or a Credit Verifier 382 who holds and shares data that validates the customer's credit rating.

Any of various permissions could be included in such a system to ensure that data is properly labelled and only certain designated data may be shared with certain designated third parties. Such a designation could be created as the customer progresses through a co-creation setup process with a vendor. During this process, the customer 302 may grant the vendor access to one, some, or all of these third party sources of validated data. In this way the process may become more efficient than current models of interaction and information exchange for both the customer and the business. Cloud storage could also be encrypted and/or password protected.

### Integration Examples

The Integration platform 240 may also include two-way integration of the platform here with third party business platforms. This may include, but will not be limited to, integration to third party CRM applications (e.g. 1 Salesforce CRM, e.g. 2 Oracle CRM, e.g. 3 SAP CRM, e.g. 4 Microsoft CRM) and third party Billing, Financial, Contact Centre, Support and other applications.

### Co-Creation Example

In certain example embodiments, the term co-creation may refer to the business model of customer and vendor together designing an experience that the customer wants that the vendor organization can deliver. The platform may go beyond some co-creation principles where an experience may be created but not fulfilled, implemented or actioned, for a range of reasons, including but not limited to, because the vendor cannot currently meet the experience requested, or because the vendor does not want to meet the experience requested. The information generated in the platform could still be pushed to other systems including, but not limited to, CRM, Product Management, Contact Centre, Marketing and Innovation. This information could be used for a range of purposes, including but not limited to, enabling the business to deliver the requested experience in the future.

For Example, if a customer has co-created their experience with an organization, the information is pushed back into the organizations back end systems and processes—hence the customer's next interaction with that said organization should change to reflect their experience preference. For Example, if the customer has co-created with the employee that they do not want to use the organization's speech recognition system when calling the business then the information related to this from the platform may be provisioned through open APIs to the contact center system. In this example, after such provisioning, the next time the caller rings the contact center, their call is routed past the speech recognition system to a live attendant. Hence an example capability of this platform is that the experience that is co-created by a customer and an employee is actioned and implemented so that the customer receives the experience they have co-created.

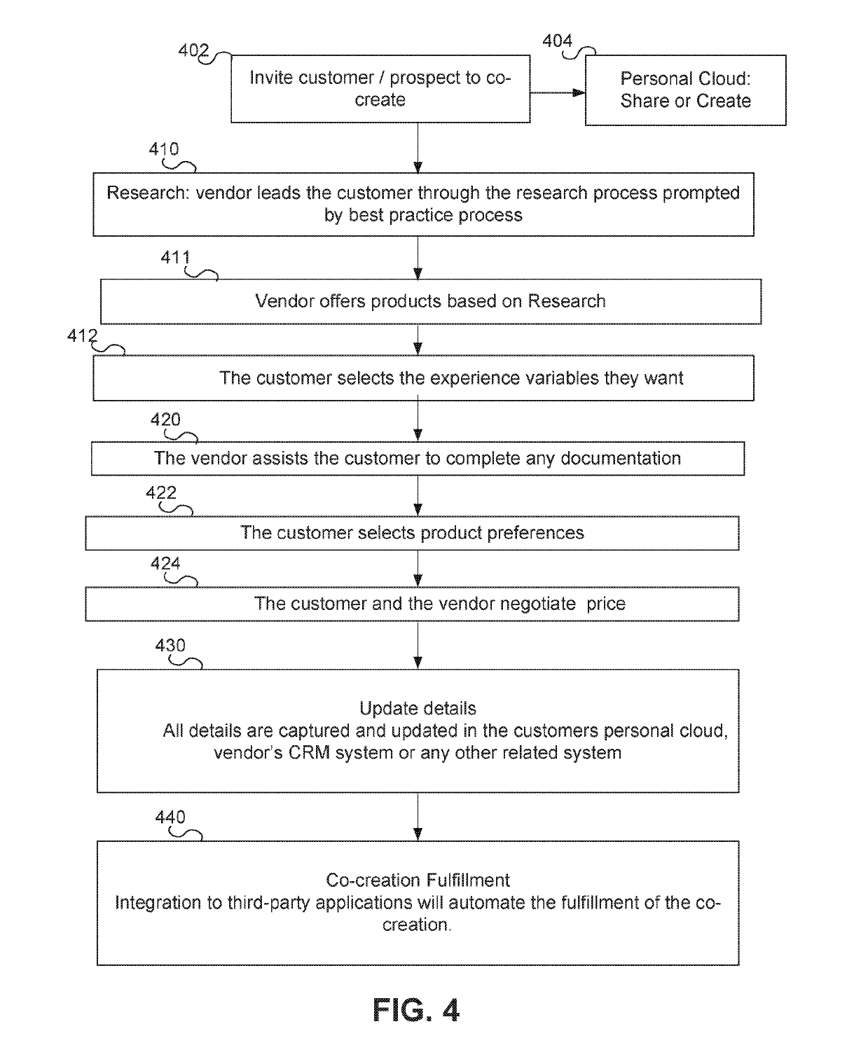

FIG. 4 shows example flow chart depicting an example process of a co-creation experience for a customer interested in buying health insurance.

For example, 402 the platform allows the system to invite the customer/prospect to co-create. This could be done via an online message from the platform system, or through a website browser GUI screen. Once the message has been sent, the customer may accept and if the customer has a Personal Cloud they may be able to share the contents of their Personal Cloud with the vendor, in this health insurance example this may include, demographic data, health data, health records. If the customer doesn't have a Personal Cloud they may create one with the vendor 404 and save information created in this example co-creation in order to share information with the vendor (or other vendors) in the future.

Next, 410 Research: the vendor may lead the customer through the research process in the online system. The platform may prompt a best practice process to be undertaken by the customer and vendor, such that Vendor may offer Research templated best practice to the customer, in this health insurance example this may be the best practice process to enquire about, for example, a customer's age, weight, marital status, blood type, allergies, history of surgery, government agency details (e.g. Medicare number in the case of Australia, Social security Number in the case of USA) etc.

Next, 411 the vendor would offer a range of products and services based on the information gathered in 410 Research. This could be by comparing the answers to questions that the customer user provides as above 410 and comparing the answers to data tables that map specific answers to various products that the particular business may offer. Over time, the system could change what products are mapped to the various answers based on input from administrators, marketing pushes, and/or machine learning that determines how best to service a customer user. Analysis of data over time may be used to chart trends in product/service selection by specific customer users, or customer users that have certain traits. Thus, products/services could be tailored to trends or could be adjusted to market influences.

Offered products could be any number of things including but not limited to: Dental care; Emergency; Family care; General care; Hospital services; Medical services; Mental health services; Nutrition and dietary services and products; Surgical care and services; Therapy services; Home health care; Immunizations; Lab testing; Major medical coverage; Medical imaging services; Medical supplies; Preferred medical specialist services; Prescription coverage; Preventative care; Primary care; State-of-the-art treatment of acute and chronic conditions; Unrestricted doctor choice; Family planning; Fertility care; Neo-natal care; Obstetrics; Pregnancy care; Pre-natal care; Vision and hearing services; Occupational therapy; Physiotherapy; Respiratory therapy; Speech therapy; Durable medical equipment; Care coordination services; Continuity of care; Essential benefits without lifetime limits; Pre-existing condition coverage; and Rehabilitation.

Next, 412 shows the customer selecting experience variables from the options offered in 411. Experience variables could be any number of things including but not limited to: the communication style(s) the customer prefers; the communication channel(s) the customer prefers; the characteristic of the people that the customer wants to interact with; the process that the customer wants to undertake with; the product options that the customer selects; and the price that the customer is willing to pay for their selected experience variables.

Next, 420 shows Co-creation Form Assist where the vendor may assist the customer to complete a form, or multiple forms.

Next, 422 Product Selection. The customer selects product preferences from a template offered by the vendor that would be informed by data already gathered in the co-creation. In certain embodiments, the template is a previously created template which may include the general areas of fields of care; general care product/service; family product/service; therapy service; technology such as durable medical equipment; and service.

In certain example embodiments, a template in a field of care may include but is not limited to: Dental care; Emergency; Family care; General care; Hospital services; Medical services; Mental health services; Nutrition and dietary services and products; Surgical care and service; and Therapy services.

In certain example embodiments, a template in a general care product/service may include but is not limited to: Home health care; Immunizations; Lab testing; Major medical coverage; Medical imaging services; Medical supplies; Preferred medical specialist services; Prescription coverage; Preventative care; Primary care; State-of-the-art treatment of acute and chronic conditions; and Unrestricted doctor choice.

In certain example embodiments, a template in a family product/service may include but is not limited to: Family planning; Fertility care; Neo-natal care; Obstetrics; Pregnancy care; Pre-natal care; and Vision and hearing services.

In certain example embodiments, a template in a therapy service may include but is not limited to: Occupational therapy; Physiotherapy; Respiratory therapy; and Speech therapy.

In certain example embodiments, a template in a service may include but is not limited to: Care coordination services; Continuity of care; Essential benefits without lifetime limits; Pre-existing condition coverage; and Rehabilitation.

Next, 424 Price Negotiation, the customer and the vendor negotiate the price of the total customer experience co-created. This may be an iterative process of offer and counter-offer.

Next, 430 Update Details, all or some of the details of the co-creation are captured and updated in the customers personal cloud, the vendor's CRM system, and any other related system.

Finally, 440 Co-creation Fulfillment: Integration to third-party applications may automate the fulfillment of the co-creation. The fulfillment in the case of health insurance may include, but not be limited to, the generating of policy numbers, the generating and sending (via post, email or other carriage service) of policy documents to the customer. In an example other than health insurance, e.g. a telecommunications company selling a mobile phone plan, the fulfillment may include the generation and sending of plan documentation and invoices, establishing the customer and customer's plan in the vendor's billing system, picking, packing and shipping of mobile phone hardware, provisioning of mobile phone numbers, etc.

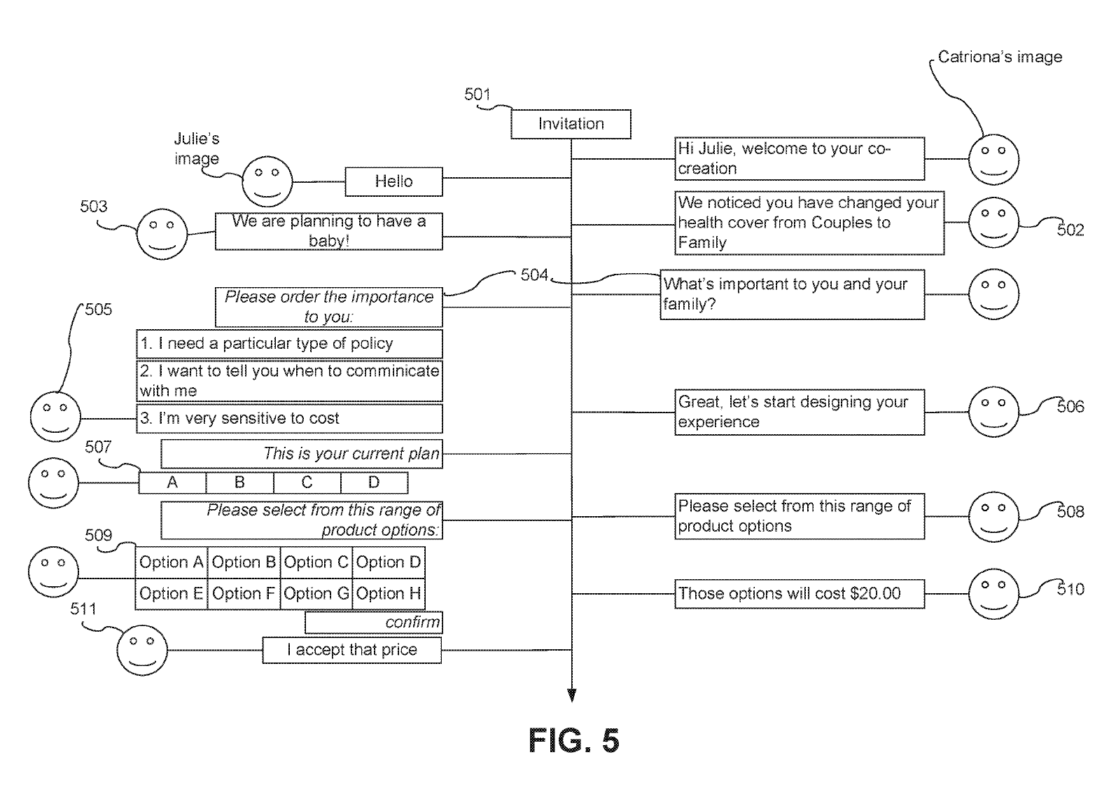

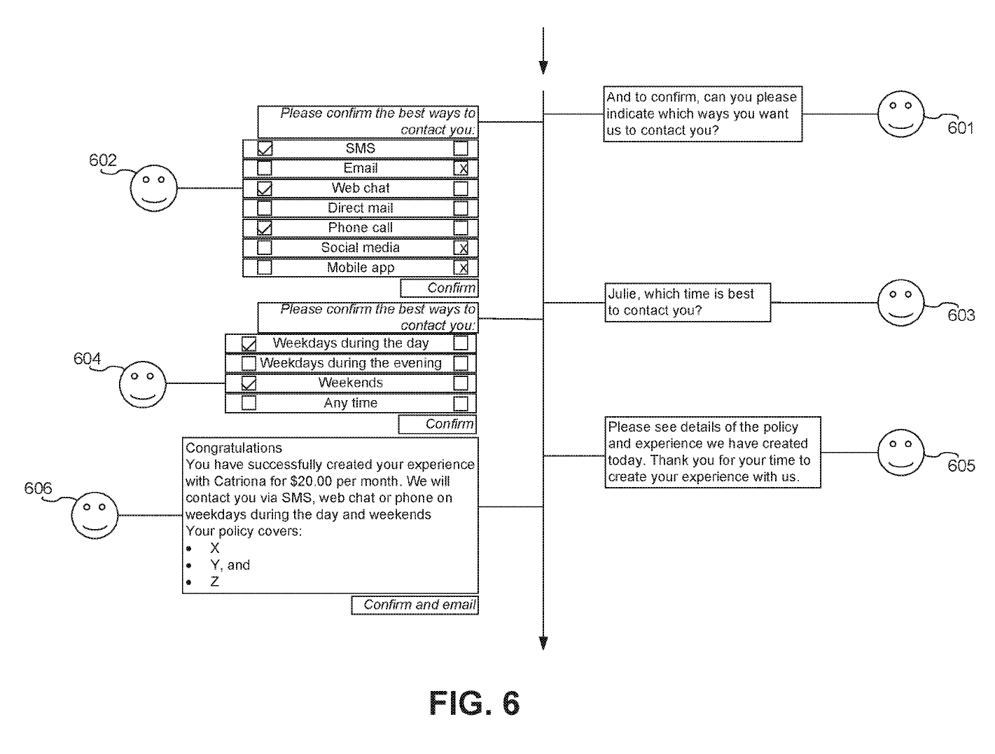

FIGS. 5 and 6 show example flow diagrams depicting a back-and-forth communication sequence using Journey Assist in a health insurance example.

FIG. 5 shows example flow chart of communications between a customer and vendor employee consistent with certain embodiments herein. The example in FIG. 5 depicts online chat bubbles that allow a customer (Julie) and vendor's employee representative (Catriona) to interact in real time over the network. The examples here are merely illustrative to show how the platform could be customized for any particular customer. And as described above, the instant message example could be any kid of video call with included icons or graphics, voice call with graphics, instant message, text message, chat or other functionality.

To begin, 501 the customer has been invited by the vendor to participate in a co-creation session. The vendor (Catriona) welcomes the customer (Julie) to the co-creation session which in this case looks like an online chat room.

Next, 502 shows the vendor setting the context of the co-creation session, i.e. that the vendor noticed the customer had changed their health insurance coverage from Couples to Families.

Next, 503 the customer tells the vendor why they changed their coverage, for example, ‘We are planning to have a baby’.

Next, 504 the vendor asks what's important to the customer and offers a range of product options to select from. The options in this case are shown as a graphical list of questions which appears on the screen for the user. These questions were pushed by the system at the prompting of the vendor employee Catriona. The graphic could be any kind of media, information, or data for the customer. It could be interactive, with check boxes or numbering systems that could be rearranged. There could be a video or audio clip that plays for the customer. A chart or interactive diagram may be included. The system is able to provide these interactive and/or informational information to the customer, receive any requested response from the system and utilize that information while recording it, and using it to inform the next set of questions or examples.

Next, 505, the customer responds to the prompts, whatever those prompts include. In this case, the customer is asked to select from a group of three options 504 505. In certain examples there could be any number of iterations of questions, utilizing best practice templates of options being offered by the vendor in response to selections by the customer.

Next, 506 the vendor invites the customer to begin designing (co-creating) their total customer experience using the answers or interactions provided by the customer in the previous steps.

Next, 507 the vendor causes display of the customer's current health coverage plan. Again, this is merely exemplary, and any kind of media could be shown to the customer here.

Next, 508 the vendor invites the customer to select between a range of product options. Again, these are displayed on the customer GUI for interaction by the customer.

Next, 509 the customer selects between the product options offered and confirms selection. The system then records the responses and utilizes the answers to drive later questions or interactions.

Next, 508 and 509 could continue through a number of iterations with many options being offered by the vendor employee in response to preferences indicated by, and selections made, by the customer.

Next, 510 the vendor offers a price for the options the customer has selected. The price could be based on any number of things that the system determines. Analysis of the particular customer may inform the price offer by the system. Market forces may inform the price offered by the system. Economics of the vendor may drive the offered price up or down depending on how badly they need a new customer or to keep this customer. Special discounts or promotions may be offered to a customer at this time as well. Package deals may be offered to keep the customer in this or to expand them into other product areas. The offer could be accepted by the customer or rejected with a counter-offer. This step may continue with offer and counter-offer until a price is agreed upon.

Next, 511 the customer accepts the offered price.

FIG. 6 shows another example screen shot depicting example user interfaces consistent with certain embodiments herein. In the example of FIG. 6, the co-creation session started in FIG. 5 is continued. The examples here are merely illustrative to show how the platform could be customized for any particular customer.

Next, 601 the vendor representative asks the customer to confirm which ways they want to be contacted. Again this is shown to the customer as a GUI interactive graphic that allows the customer to click which offered methods she prefers. Any kind of interactive media may be presented to the customer in order to elicit preference responses.

Next, 602 the customer confirms which ways they want to be contacted. The system records the preferences and utilizes that information in analytics based on the identity of the customer.

Next, 603 the vendor representative asks the customer which times they want to be contacted. Again this is in the form of interactive media pushed to the customer's display.

Next, 604 the customer confirms which times they want to be contacted. The system records this information and utilizes it to ensure that the customer is contacted as she has indicated.

Next, 605 shows the vendor confirming a successful experience creation with the representative. The vendor wraps up the co-creation.

Next, 606 the vendor documents the outcome of the co-creation to the customer through a pushed media display. The system could also send a summary of the interaction and eventual product/service selection via another form of communication such as email, text, traditional paper mail, or other communication.

FIG. 7 shows a detail of a flow chart of an example Acquisition Mode according to certain embodiments. In the example, via the networked communications system described here, the vendor leads the customer through various reference selections. This process of leading the customer could be the vendor interacting with the customer via a networked communication session. Examples of such are shown above in the examples in FIGS. 5 and 6.

Further, each of the selection offerings that the vendor may lead the customer through below, could be populated with best practices previously determined by the system. For example, depending on what field the customer is in, the system may identify preset selections for each category below. Then, when the vendor prompts the system to offer the preference selections to the customer in each step, the UI may be already filled out, or the selection options presented may be driven by the previously determined best practices. In any arrangement, the vendor may have been involved in the previous selection of the options, or the system may have suggested them to the vendor.

In the example of FIG. 7, the invite to the customer to co-create is first sent 702. Next, via the personal cloud 704, if the customer has such storage available and utilized, the vendor leads the customer through communication preferences which may be prompted by previously stored best practices 706. Further, the preferences may come from a third party, via the network, for integration 700 from what the third party system uses. Once the communication preferences are established, the vendor could lead the customer through a selection of channel preferences 708. Next, the vendor may lead the customer through people preferences 710 and then process preferences 712. Then the vendor may lead the customer through product preferences 714 and then a price negotiation session 716. Again, at this point, the interaction with the personal cloud may be made with storage of the preference selections 718. Further, the preferences may be sent to a third party, via the network, for integration 720 into what the third party system uses.

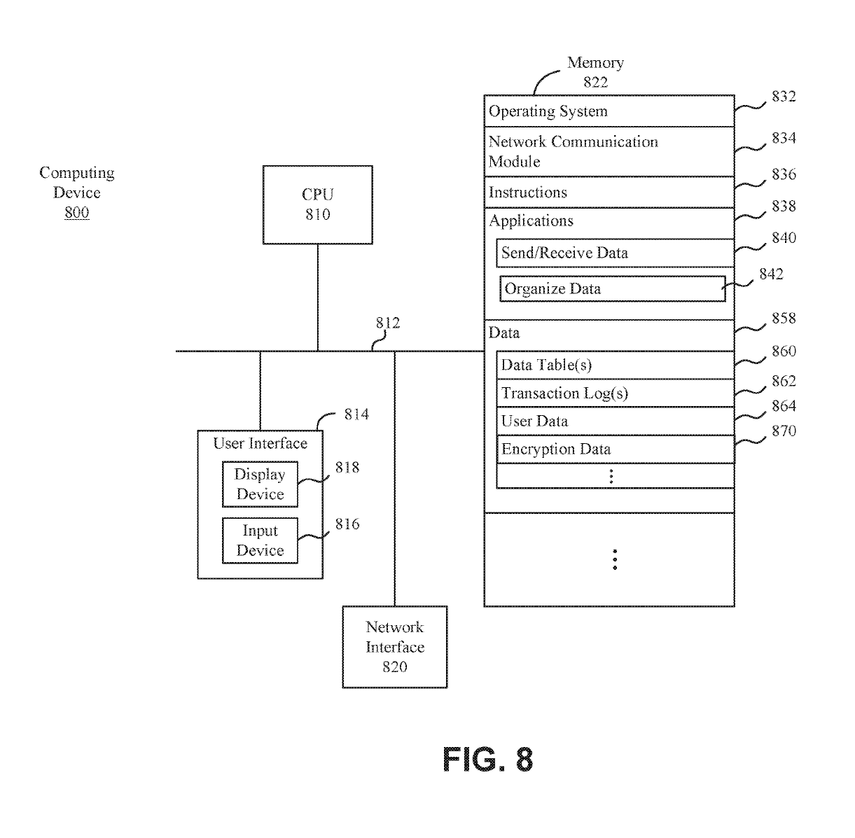

FIG. 8 shows an example computing device 800 which may be used to practice certain embodiments disclosed herein. The example computing device could be any kind of server, personal computer, mobile computing device, or any kind of computing device. The example of FIG. 8 includes a processor CPU 810. This could be a single or multiple processors. The processor 810 communicates via a bus 812 or other communication way to other features such as a user interface 814. The example user interface 814 includes here a display device 818 and input device 816. Such an example user interface need not be hard wired to the computing device 800 but could be remotely connected via a network or other system. Also present in the example is a network interface 820. The network interface 820 allows the computing device to communicate with other computers through wired or wireless methods. The computing device 800 also includes a memory 822 which can store and execute software instructions. The memory 822 includes an operating system 832, network communication module 834, instructions 836 and applications 838 such as send/receive data 840 and organize data 842. Also included is data storage 858 such as data tables 860, transaction logs 862, user data 864 and encryption data 870. Other examples could include other software and data examples as well.

### CONCLUSION

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense, that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A platform for allowing multiple parties to coordinate, comprising:
one or more computer servers and databases in communication with each other,
the computer servers and databases configured to,
to run the platform and allow a vendor user to,
invite a customer user to use the platform via the network;
research the customer user by sending questions to the customer user and receive responses to the questions from the customer user;
wherein the questions include stored platform questions;
prompt the customer user to upload personal information from a personal networked storage;
send the customer user a product preferences template;
receive answers to the product preferences template from the customer user via the network; and
offer products to the customer user based on the received responses.

2. The platform of claim 1 further comprising, via the computer server,
offering experience variables to the customer via the network, and store the answers in order to customize the communication with the customer, the experience variables including at least one of,
a communication style the customer prefers;
a communication channel the customer prefers;
a characteristic of the people that the customer wants to interact with;
a process that the customer wants to undertake with;
a product option that the customer selects; and
a price that the customer is willing to pay for their selected experience variables.

3. The platform of claim 1 wherein the offered products are at least one of:
Dental care; Emergency; Family care; General care; Hospital services; Medical services; Mental health services; Nutrition and dietary services and products; Surgical care and services; Therapy services; Home health care; Immunizations; Lab testing; Major medical coverage; Medical imaging services; Medical supplies; Preferred medical specialist services; Prescription coverage; Preventative care; Primary care; treatment of acute and chronic conditions; Unrestricted doctor choice; Family planning; Fertility care; Neo-natal care; Obstetrics; Pregnancy care; Pre-natal care; Vision and hearing services; Occupational therapy; Physiotherapy; Respiratory therapy; Speech therapy; Durable medical equipment; Care coordination services; Continuity of care; Essential benefits without lifetime limits; Pre-existing condition coverage; and Rehabilitation.

4. The platform of claim 1 wherein the product preferences template is in a field of care including but not limited to: Dental care; Emergency; Family care; General medical care; Hospital services; Medical services; Mental health services; Nutrition and dietary services and products; Surgical care and service; and Therapy services.

5. The platform of claim 1 wherein the product preferences template is a general care product/service is at least one of: Home health care; Immunizations; Lab testing; Major medical coverage; Medical imaging services; Medical supplies; Preferred medical specialist services; Prescription coverage; Preventative care; Primary care; treatment of acute and chronic conditions; and Unrestricted doctor choice.

6. The platform of claim 1 wherein the personal information uploaded by the customer is used to determine which product preferences template is used.

7. The platform of claim 1 wherein the product preferences template is a therapy service including at least one of: Occupational therapy; Physiotherapy; Respiratory therapy; and Speech therapy.

8. The platform of claim 1 wherein the received answers to the product preferences template informs later questions to ask the customer regarding the product.

9. The platform of claim 1 wherein the computer server is further configured to,
store details in the database, wherein details include,
the responses to the questions and answers to the product preferences template; and
send the stored details to a third party application server via the network.

10. The platform of claim 1 wherein the database is a networked data storage accessible by both the customer and the computer server.

11. A platform to allow networked coordination of medical services vendors and customers, comprising:
a server in communication with a data storage and a network;
the server configured to run the platform to,
allow customer users to log into the platform via the network;
prompt the customer users to upload their medical/personal data to the data storage;
cause storage in the data storage of uploaded customer user data;
prompt the customer user to identify personal preferences;
receive identified customer user personal preferences;
based on the identified customer user personal preferences,
prompt the customer user to choose a product/service;
select a stored template based on the chosen product/service;
load the stored data into the selected template;
prompt the customer user to answer questions based on the chosen template;
receive answers to the questions and load the answers into the selected template; and
send the template to a third party application server.

12. The platform of claim 11 wherein the server is further configured to,
store details in the data storage, wherein details include,
the chosen product/service and the answers to the questions; and
utilize the answers to the questions to modify the product template for later use.

13. The platform of claim 11 further comprising, via the server,
correlating the received personal preferences from the user to product/service offerings; and
use the correlated product/service offerings to prompt the customer user to choose the product/service.

14. The platform of claim 11 wherein the communication between the customer user and vendor is via an instant message display accessed by each over the network.

15. A platform to allow networked coordination of medical services vendors and customers, comprising:
a processor in communication with a memory, data storage and a network, the processor configured to execute instructions for,
communicating with a customer via the network using instant messages;
recalling a template for research questions, based on a type of product requested by the customer;
sending questions to the customer from the template;
receiving answers to the questions from the customer;
correlating the answers to the questions with product offerings;
sending product offerings to the customer based on correlated answers;
receiving a product selection of the product offerings from the customer; and
causing storage in the data storage of the answers to questions, experience variable responses and product selection.

16. The platform of claim 15 wherein the correlating answers to the questions with product offerings includes matching answers to the questions with data tables for product offerings.

17. The platform of claim 15 wherein the processor is further configured to execute instructions for,
sending experience variables to customer; and
receiving experience variables responses.

18. The platform of claim 15 wherein the processor is further configured to execute instructions for,
sending an invitation to the customer to begin the communications; and
receiving an acceptance of the invitation.

19. The platform of claim 15 wherein the template for research questions is stored in the data storage and is changed over time based on trending market feedback.

20. The platform of claim 17 wherein the experience variables are at least one of,
the communication style the customer prefers;
the communication channel the customer prefers;
the characteristic of the people that the customer wants to interact with;
the process that the customer wants to undertake with;
the product options that the customer selects; and
the price that the customer is willing to pay for their selected experience variables.

21. The platform of claim 15 wherein the processor is further configured to execute instructions for, sending the product selection to a third party application via the network.
